(19) United States
(12) Patent Application Publication
(10) Pub. No.: US 2015/0255050 A1
(43) Pub. Date: Sep. 10, 2015

(54) HOLDER FOR SWITCH OF INSTRUMENTS' POSITIONS (FAST PICK)

(71) Applicant: Andres Felipe Diaz Lopez, Oxford, MS (US)

(72) Inventor: Andres Felipe Diaz Lopez, Oxford, MS (US)

(21) Appl. No.: 14/203,413

(22) Filed: Mar. 10, 2014

(51) Int. Cl. G10D 3/16; F16M 13/04

(52) U.S. Cl. CPC G10D 3/163; F16M 13/04

(57) ABSTRACT

This application describes a Fast Pick and its respective method of use. This Fast Pick comprises an instrument holder (10) for quickly mounting and dismounting small instruments (30, 32, 34, 36, 38) and a means to attach said instrument holder near to the fingers (20, 22) in such a way that a performer can easily place or displace said instrument (30, 32, 34, 36, 38) in or out the hand, hence, easily switching between two operation modes, one in which the instruments can be taken by the fingers (e.g. FIG. 6) and one in which the instruments do not interfere with the fingers free movement while remaining reachable to the fingers (e.g. FIG. 5, FIG. 7).

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

Not applicable.

### BACKGROUND OF THE INVENTION

This application refers to a holder of small instruments or tools of intermittent use. It has a particular application in the use of picks for strumming stringed musical instruments. The following is a list of relevant prior art:

| Title | Patent No. | Author(s) | Date |
|---|---|---|---|
| Plectrum mounting apparatus and | 7,799,979 | Swartz; Patrick | Jul. 22, 2010 |
| method of use | | Neil | |
| Pick assembly for playing a | 7,589,267 | Sims; Arthur | Sep. 15, 2009 |
| stringed musical instrument | | | |
| Adjustable thumb pick for stringed | 6,949,700 | Kelly; Fred | Sep. 27, 2005 |
| instruments | | | |
| Elastically held guitar pick | 3,648,558 | Chenette; John E. | Mar. 14, 1972 |
| Stringed instrument strumming/ | 6,797,871 | Atkin; Greg M. | Sep. 28, 2004 |
| picking apparatus and method | | | |
| Holder for mandolin picks | 557,293 | F. Wahl | Mar. 31, 1896 |
| Guitar pick Attachment for the | 2,776,592 | M. S. Di Preta | Jan. 8, 1957 |
| forefinger | | | |
| Guitar pick device | 3,789,720 | McIntyre; | Feb. 5, 1974 |
| | | Thomas M. | |
| Finger ring with plectrum | 4,270,433 | Adamec; Robert | Jun. 2, 1981 |
| Guitar pick | 4,497,237 | Beall; Mark A. | Feb. 5, 1985 |
| Guitar pick | D291809 | Jasper; Robert S. | Sep. 8, 1987 |
| Picks for stringed musical | 5,864,075 | Mapson; James L. | Jan. 26, 1999 |
| instruments | | | |
| Guitar pick | 5,973,243 | Christenson; Eric | Oct. 26, 1999 |
| | | J. | |
| Musical instrument pick having | 6,118,058 | Rowley; Peter | Sep. 12, 2000 |
| finger attachment means | | | |
| Finger ring and pick in combination | 6,977,330 | Santa Cruz; Cathy | Dec. 20, 2005 |
| for playing a musical instrument | | D. & Squillante; | |
| | | Paul A. | |
| Plectrum holder | 20060117931 | Benyahia, | Jun. 8, 2006 |
| | | Yacine; & Tosto, | |
| | | Carmelo | |
| Plectrum holder | 7,371,950 | Benyahia, | May 13, 2008 |
| | | Yacine; Tosto, | |
| | | Carmelo | |
| Index finger mounted guitar pick | 20090139384 | Bramucci; Robert | Jun. 4, 2009 |

Some activities require intermittent manipulation of small instruments or tools with the hands. This is the case of the work of watchmakers, musicians, electronics assemblers, and other artisans who constantly have to switch among operating with different instruments in their hands and operating with their hands free of any tool. These activities require a quick change between these two operation modes. Sometimes the tools have to be left aside in order to operate with the hands free or to grab a different instrument. Yet, the instrument has to remain at reachable distance ready to be used again.

Two problems are involved in these operations. First, small instruments can be lost; and second, the time between operation modes can be critical for optimal performance. A particular case of this type of activities is playing a stringed musical instrument such as a guitar. It is in this field where we find some attempts to deal with this issue. Guitar players use essentially two operation modes for strumming the strings, one is fingerpicking or strumming the strings directly with the fingers and the other is flatpicking or strumming the strings with an instrument called pick. A pick can have many forms, but a standard embodiment of it usually is a thin, flat, triangular shingle that performers hold between the thumb and the index fingers. Flatpicking is used to produce louder and brighter sounds and to achieve fast repetitive strokes, while fingerpicking allows simultaneous strokes by the fingers acting independently. The combination of both styles in a single piece is very limited in part due to the lack of appropriate devices that can hold a preferred pick at reachable distance so it can be rapidly put in position to be used or discarded without losing the ability to reach it again.

Some inventions such as U.S. Pat. No. 7,589,267 (Sims, 2009), U.S. Pat. No. 6,949,700 (Kelly, 2005), U.S. Pat. No. 3,648,558 (Chenette, 1972), U.S. Pat. No. 6,118,058 (Rowley, 2000), U.S. Pat. No. 6,977,330 (Santa Cruz & Squillante, 2005), and 20060117931 (Benyahia & Tosto, 2006) have attempted to facilitate the use of picks by providing pick holders attached to the performer or to the musical instrument, but they fail to facilitate a fast switch between the two operation modes. Other inventions such as U.S. Pat. No. 6,797,871 (Atkin, 2004), 557293 (Wahl, 1986), U.S. Pat. No. 2,776,592 (Di Preta, 1957), U.S. Pat. No. 3,789,720 (McIntyre, 1974), U.S. Pat. No. 4,270,433 (Adamec, 1981), D291809 (Jasper, 1987), U.S. Pat. No. 5,864,075 (Mapson, 1999), U.S. Pat. No. 5,973,243 (Christenson, 1999) and 20090139384 (Bramucci, 2009) provide a way to switch between the two operation modes, but they use a single pick mounted device making it very difficult or expensive to use different picks or a preferred pick. Some other inventions such as U.S. Pat. No. 7,799,979 (Swartz, 2010) and U.S. Pat. No. 4,497,237 (Beall, 1985) attempt to overcome both limitations, but do it with unnecessary complex devices or non-ergonomic structures.

In summary, none of the previous inventions have achieved the complete functionality needed for such a device and none of them has had the commercial acceptation that this demanded solution deserves. For example, the Plectrum mounting apparatus and method of use in U.S. Pat. No. 7,799,979 (Swartz, 2010) allows switching between fingerpicking and flatpicking positions of the pick by means of a spring and moving the pick about the finger, which renders a complex apparatus and a non-ergonomic position for flatpicking. In this position the pick rests on the intermediate phalanx and not on the distal phalanx as it should. This apparatus restricts the use of different pick's shapes and does not adjust to different lengths of fingers.

The Pick assembly for playing a stringed musical instrument in U.S. Pat. No. 7,589,267 (Sims, 2009) and the Adjustable thumb pick for stringed instruments in U.S. Pat. No. 6,949,700 (Kelly, 2005) are picks limited to the thumb, not pick holders for all and any finger. The former does not allow switching from fingerpicking to flatpicking styles and the latter does not allow interchanging standard picks.

The Elastically held guitar pick in U.S. Pat. No. 3,648,558 (Chenette, 1972) is a pick, not a pick holder. It does not allow switching between fingerpicking and flatpicking styles. The Stringed instrument strumming/picking apparatus and method in U.S. Pat. No. 6,797,871 (Atkin, 2004) is restricted to the thumb and needs modifications of the pick. Thus standard picks cannot be placed on it easily. The Holder for mandolin picks in Pat. 557293 (Wahl, 1986) is claimed to be limited for a mandolin and the concavo-convex disks holding the pick are unnecessary convoluted. The pick is attached to the disks, so it requires a special pick with a hole. It does not allow placing standard picks in it. Removing and mounting picks is complex and tedious with this system.

The Guitar pick Attachment for the forefinger in U.S. Pat. No. 2,776,592 (Di Preta, 1957) is restricted to forefingers. Moreover, this is not a holder for picks but a pick connected to a ring. Thus, different picks cannot be used with the same holder. The movable arm cannot be adjusted to different lengths and cannot hold multiple picks. The Guitar pick device in U.S. Pat. No. 3,789,720 (McIntyre, 1974) requires a special pick with holes and lacks an adjustable arm to place the pick in a comfortable position according to different finger lengths. In addition, it is designed to be mounted in the distal phalanx where it interferes with the fingering operation mode of strumming the strings. The Finger ring with plectrum in U.S. Pat. No. 4,270,433 (Adamec, 1981) is restricted to the middle finger, does not have an arm to adjust the position of the pick and the pick needs holes. Standard picks cannot be adapted. In the Guitar pick in U.S. Pat. No. 4,497,237 (Beall, 1985) the position for fingerpicking is very restricted because the pick remains pointing towards the strings and can accidentally strum a not desire string. The extreme care that the player would need to avoid this interference makes this idea non-viable in real performances.

The Guitar pick in Pat. D291809 (Jasper, 1987) and the Picks for stringed musical instruments in U.S. Pat. No. 5,864,075 (Mapson, 1999) are picks with a ring, not holders. Thus, the picks are not interchangeable. The Guitar pick in U.S. Pat. No. 5,973,243 (Christenson, 1999) is not a holder, and does not allow switching between fingerpicking and flatpicking positions. In the Musical instrument pick having finger attachment means in U.S. Pat. No. 6,118,058 (Rowley, 2000) the pick cannot be taken out and a chain is a structural part of the invention, which makes it an unnecessary convoluted design considering that switching between styles is not well achieved. The pick cannot be recovered rapidly once it is discarded. Likewise, the Finger ring and pick in combination for playing a musical instrument in U.S. Pat. No. 6,977,330 (Santa Cruz & Squillante, 2005) uses a tether to connect the ring and the pick holder. This tether lacks the stability required to keep the pick out of the area of strumming when finger picking style is desired.

The Plectrum holder in patents 20060117931 (Benyahia & Tosto, 2006) and U.S. Pat. No. 7,371,950 (Benyahia & Tosto, 2008) are just holders where to place a pick, but do not have the functionality of positioning the pick for fingerpicking or flatpicking styles. It is unlikely that by using these inventions the player would be able to rapidly place the pick back in the holder using one hand. The Index finger mounted guitar pick in patent 20090139384 (Bramucci, 2009) is not a holder that allows mounting different picks. The pick is permanently fixed to the ring, and the invention is limited to the index finger.

Finally, all these inventions are limited to handling picks. Therefore, they do not address the more general use and functionality of a holder to manipulate instruments used in other activities such as electronics, medicine, handcrafting, among others, wherein the frequent switch between using and not using small tools is needed.

### BRIEF SUMMARY OF THE INVENTION

In accordance with one embodiment, a holder for switch of instruments' positions or Fast Pick comprises an instrument holder for quickly mounting and dismounting small or light instruments or tools and a means to attach said instrument holder near to the fingers in such a way that it allows easily switching between two operation modes, one in which the instruments can be taken by the fingers and another in which the instruments do not interfere with the fingers free movement, but remain reachable for the fingers.

### Advantages

This embodiment presents several advantages, for example: to provide a means to hold one or more instruments such as picks, blades, brushes, pens, screwdrivers or flashlights close to the fingers and ready to be manipulated; to speed the change between two operating settings, one in which the fingers manipulate the instruments and the other performing with the fingers free of those instruments; and to easily mount and dismount the instruments to be manipulated. It is another advantage of this embodiment over prior art, that it is very easy to manufacture. Although a complex design involving expensive materials and mechanisms can be developed, one functional model of a fast pick was built with a piece of a bicycle tube, two pieces of balsa wood and a tack.

### BRIEF DESCRIPTION OF THE SEVERAL VIEWS OF THE DRAWING

FIG. 1 shows one embodiment of the Fast Pick.

FIG. 2 shows the instrument holder 10 used in FIG. 1, where a cover splint 10C is bended up to facilitate placing a pick between the splints' end 10E.

FIG. 3 shows the attaching mechanism 20 used in FIG. 1 with the rivet 202 going through the instrument holder 10 of FIG. 2.

FIG. 4 shows a standard pick 30.

FIG. 5 shows one embodiment of the Fast Pick mounted on an index finger and holding a pick in the position of flatpicking.

FIG. 6 shows how, by means of a circular movement, the pick is moved out of the fingers, allowing the player to perform fingerpicking style.

FIG. 7 shows how, through a linear movement, the pick is moved out of the fingers, allowing the player to perform fingerpicking style.

FIG. 8 shows an alternative embodiment of the Fast Pick in which the instrument holder holds multiple instruments: a brush and a scalpel.

FIG. 9 shows an alternative embodiment of the Fast Pick wherein the attaching mechanism is a glove holding two different instrument holders.

FIG. 10 shows a releasable mechanism whereby a slider holding a pick can be released automatically by pressing a button and put back into the initial position by sliding the slider backwards.

FIG. 11 shows the slider of the releasable mechanism of FIG. 10.

FIG. 12 is a longitudinal cross-section image of the releasable mechanism of FIG. 10 in the restrained position.

FIG. 13 is a longitudinal cross-section image of the releasable mechanism of FIG. 10 in the released position.

Drawings - Reference Numerals

| | |
|---|---|
| 10 Instruments Holder - Splints | 142 Elastic Band |
| 10B Base Splint | 16 Instruments Holder - |
| | Releasable |
| 10C Cover Splint | 162 Slider |
| 10E End of the Splints | 1622 Slider Spring |
| 102 Round Holes | 1624 Slider Hole |
| 104 Slit | 164 Slideway |
| 106 Receptacle for brush | 1642 Button |
| 12 Instruments Holder - Retractable | 1644 Button Spring |
| Mechanism | 20 Attaching Mechanism - Ring |
| 14 Instruments Holder - Swivel | 202 Movable Mechanism - Rivet |
| 22 Attaching Mechanism - Glove | 34 Instrument - Brush |
| 30 Instrument - Pick | 36 Instrument - Flash Light |
| 32 Instrument - Craft Knife | 38 Instrument - Scalpel |

### DETAILED DESCRIPTION OF THE INVENTION

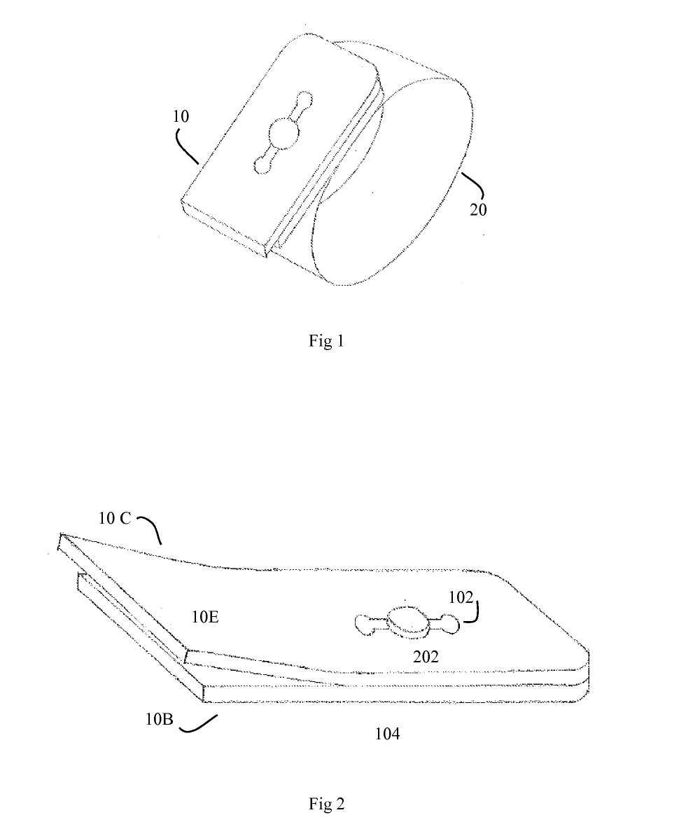

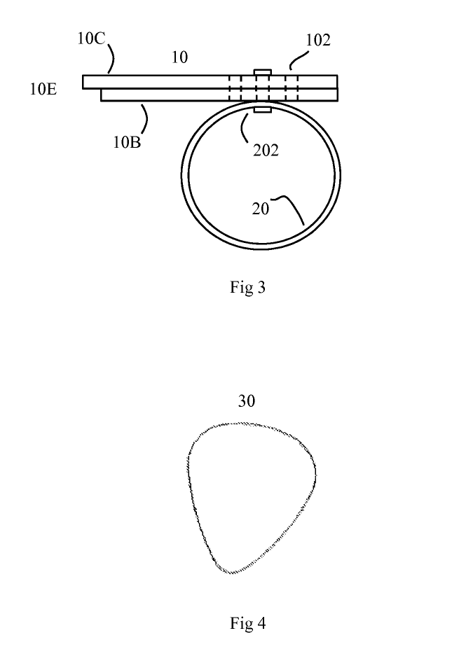

FIG. 1 shows one embodiment of a holder for switch of instruments' positions comprising an instrument holder 10 and an attaching mechanism 20. The instrument holder 10 is comprised by two thin splints, one splint being the base 10B and the other being the cover 10C. These splints have multiple coincident round holes 102. There is an attaching mechanism 20, which in this case is a ring with a rivet, tack or screw 202. This rivet keeps the splints attached to the ring, so that said rivet works as a pivot for the splints according to which of the coincident holes is crossed by the rivet. There is a slit 104 connecting the holes 102. The width of this slit is slightly smaller than the diameter of the body of the rivet 202 to allow sliding the holder from one hole to another by applying mild pressure with other fingers of the same hand wearing the instrument holder. The rivet, the splints or both are made of semi-rigid materials such as plastic, wood, leather or any other that deforms enough as to allow the body of the rivet the transit through the slit.

The base 10B and cover 10C splints are kept together by means of the pressure of the rivet 202. In this disposition, the two splints can be separated at their end 10E in order to place an instrument such as a pick 30 (shown in FIG. 4) between them. This pick remains in such a position by means of the pressure that the splints exert towards each other. These splints can be made of any material that allows the slight bend required to place a thin instrument between them while keeping said instrument in place unless an external pressure is applied to remove it. The splints do not have to be of the same shape. In fact, a difference between them, for example, having the base 10B slightly shorter than the cover 10C, facilitates the operation of grabbing one to separate it from the other in order to place a pick between them.

The attaching mechanism 20 in this embodiment is a ring made of an elastic material that permits its adjustment to different finger sizes. However, it can be made of plastic, leather, fabric or any other material, even if such a material does not allow adjusting it to different finger sizes, as it can be designed for one specific size.

### Operation

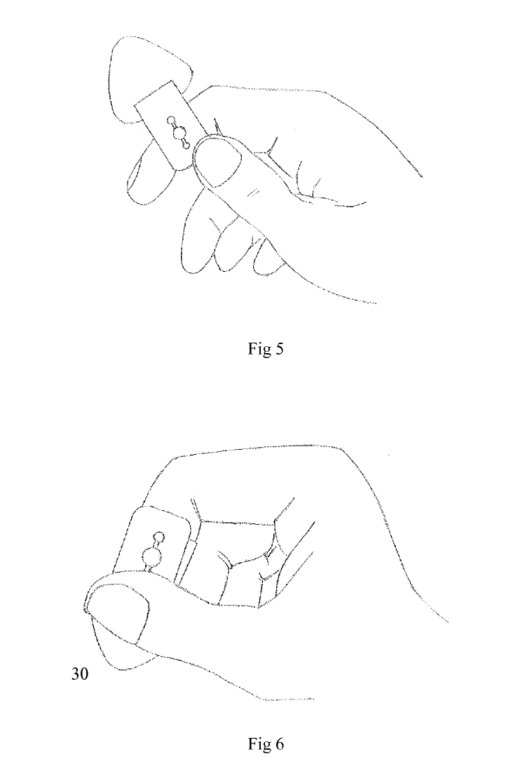

To operate this embodiment of the holder for switch of instruments' positions, a finger is introduced into the attaching mechanism 20 up to a comfortable position. For example, in FIG. 5 this mechanism is worn in the intermediate phalanx of the index finger.

A small instrument is placed in the instrument holder 10 by separating the splints' ends 10E, as shown in FIG. 2, placing the instrument between them, and then releasing them to let them exert pressure on the instrument, thus keeping it attached to the instrument holder.

In FIG. 4 the instrument is a guitar pick 30.

A guitar player is able to flat pick the strings by using his or her thumb to pull the instrument holder to a position where the pick can be grabbed by the thumb and index fingers as in FIG. 5.

Accordingly, the performer is able to finger pick the strings by using the thumb finger to push the instrument holder away from the finger tips as shown in FIG. 6.

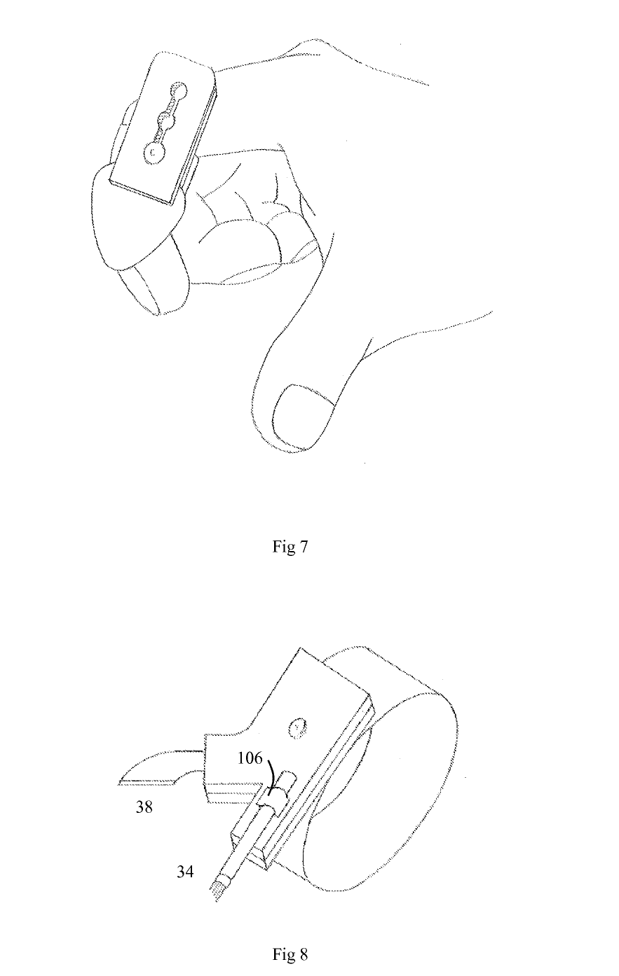

This embodiment allows the performer adjusting the position of the pick to a comfortable distance by means of sliding the splints along the pivot to one of the three round holes. This movement requires only pressure of the thumb on the splints in the desired direction and can be used as an alternative means of switching between flatpicking and fingerpicking styles when a retracted position of the splint is enough for the performer to be able to finger pick without being hindered by the pick as shown in FIG. 7.

The embodiments in FIG. 1 can hold one pick. However, it allows easily removing and mounting a different pick by applying pressure on the pick to remove it and mounting another pick by simply separating the splints and placing it between them, as described previously.

### Advantages

This embodiment is easily mounted on the performer's hand and permits placing an instrument in the holder and keeping it at reachable distance of the fingers. Despite the close location of said instrument, the performer can easily switch between operating with the instrument in her/his fingers and operating with her/his fingers free of the instrument without losing the instrument. The switch between these positions is performed by moving the splints around the pivot with a free finger. This embodiment also allows adjusting the distance of the instrument to a comfortable grip of the fingers by simply applying pressure with the fingers to slide the splints along the pivot.

### Alternative Embodiments

In the embodiment shown in FIG. 1 the base 10B and cover 10C splints are kept together by means of the pressure of the rivet 202. However, they can also be kept together by means of an elastic band, glue or any other means as long as this means allows the separation of the end 10E of the splints in order to place an instrument such as a pick 30 between the two of them. These splints can have any shape, rectangular, circular, with multiple endings (as in FIG. 8), etc. and can be made of any material that allows the slight bend required to place a thin instrument between them while keeping the instrument in place unless an external pressure is applied to remove it.

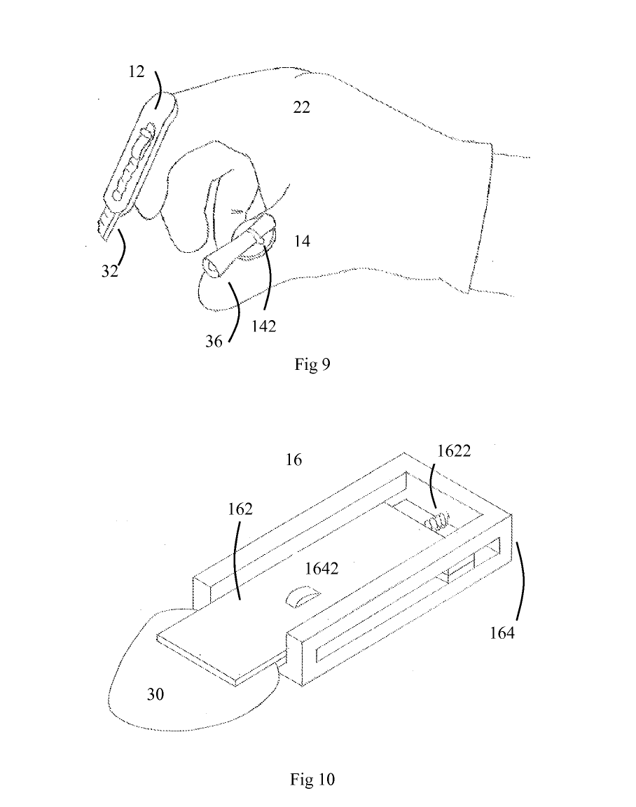

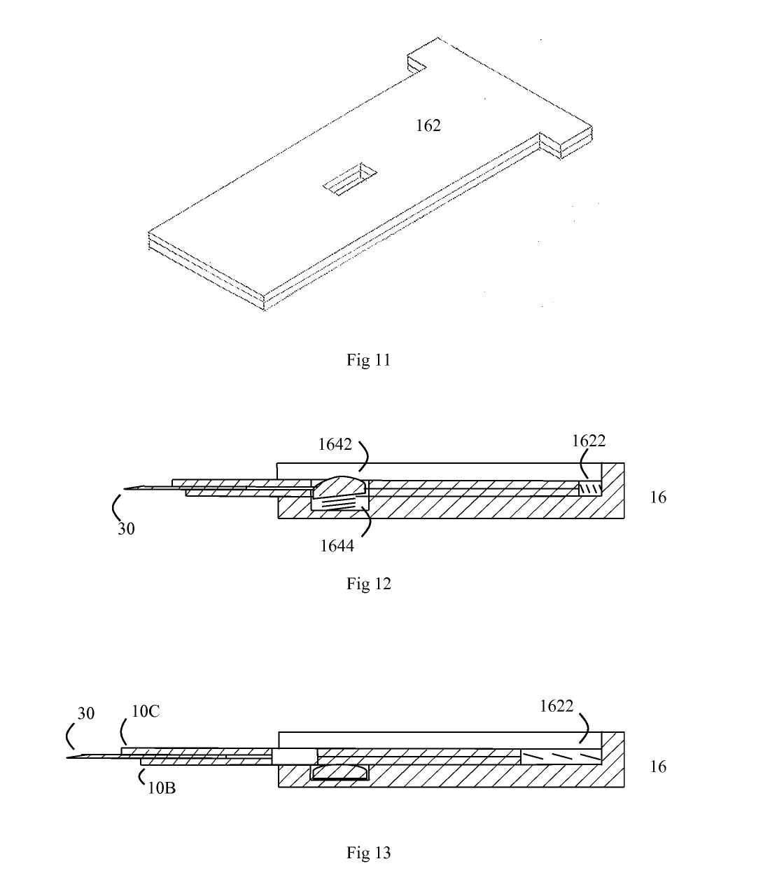

In other embodiments the instrument holder is any structure to which an instrument can be attached. For example, in FIG. 9 the instrument holder for the craft knife 32 is a retractable mechanism 12 and the instrument holder for the flash light 36 is a swivel 14 with a small elastic band 142.

The attaching mechanism 20 in FIG. 1 is a ring made of an elastic material that permits its adjustment to different finger sizes, but it can be of any material, for example plastic, metal, wire, synthetics, ceramics, wood, etc. This attaching mechanism can be worn on any finger or on the hand or on the foot. For example, in FIG. 9 the attaching mechanism is a glove 22. Other attaching mechanisms include a hook-and-loop fastener, a strip, a belt, a strap, a band, a discontinuous ring or any other structure or adjustable accessory. These alternative attaching mechanisms can also be made of synthetic material, plastic, wood, leather, metal, or any other natural or manufactured material. The elasticity of some materials facilitates adjusting the attaching mechanism to different finger or wrist sizes. However, embodiments designed for specific sizes are included as alternatives. Moreover, a hook-and-loop strap is an example of a non-elastic material that can be adjusted to different sizes. Therefore, no limitations should be interpreted in the material used in this attaching mechanism.

In FIG. 1 the attaching mechanism has a rivet, which is the part that connects to the instrument holder. In other embodiments this connection is achieved by other means. For example, in FIG. 9 the retractable mechanism 12 and the swivel 14 are glued to the glove. Tacks, screws, strings, magnets, tape or other elements can be used to keep the attaching mechanism and the instrument holder together.

The ways in which the instruments or small tools are attached to the instrument holder can also be diverse. In FIG. 8 the brush 34 is nailed into a cavity 106 designed for it, while the flash light 36 in FIG. 9 is secured by an elastic strap 142.

Another simple embodiment of the holder for switch of instruments' positions is comprised by two hook-and loop straps connected by a rivet, one strap can be used as a ring to wear on a finger and the other strap is used as holder of an instrument such as a pen. The rivet keeps the straps together while allowing the movement of the pen inside and outside the writer's grip.

More complex embodiments of the fast pick are allowed an included in this description, as in FIG. 9 wherein the attaching mechanism of an alternative embodiment of the fast pick is a glove holding two different instrument holders. On the index finger there is a craft knife 32 mounted on an instrument holder with a retractable mechanism 12 to switch the positions of this craft knife. On the thumb finger there is a flash light 36 mounted on an instrument holder 14 that can be swiveled to switch positions.

Although in FIG. 1 the instrument holder rotates around a pivot mechanism, in other embodiments the instrument holder or the instrument itself slides along a slideway to at least two positions, one in which the instrument can be taken by the fingers and one in which the instrument does not interfere with the fingers free movement. Other embodiments may use a hinge, a releasable or a retractable mechanism to move the instrument in and out of the hands.

Another alternative embodiment has a holder in which multiple instruments can be mounted as in FIG. 8 wherein a brush 34 and a scalpel 38 are mounted on the same instrument holder. According to this functionality, a guitar player, for example, can have a soft pick and a hard pick in the same instrument holder. The guitar player can also have different types of picks in different instrument holders, for example one in the index finger and another in the middle finger. Likewise, other embodiments have several holders as part of the same unit, as in FIG. 9 wherein the glove carries the holder for the knife 12 and the holder for the flash light 14. The holder for the knife and the knife in it are commercially found as one unit. Therefore, the cases where the holder is replaced by the instrument itself are included in the alternative embodiments.

FIG. 10 shows an embodiment of an instrument holder that is a releasable mechanism 16. This mechanism moves the instrument in and out of the hand by sliding the part 162 holding the instrument in a straight line on a slideway 164. However, unlike previous descriptions, this slider is released automatically by pressing a button 1642. As shown in the cross section in FIG. 12, there is a button restraining the slider part in a restrained position. When the button is pushed inside the body of the slideway 164, the slider 162 is boosted by a spring 1644 to the released position shown in the cross section of FIG. 13.

The operation of this releasable mechanism comprises pushing the button 1642 to release the slider holding the instrument so that this instrument can be grabbed by the fingers. Conversely, the restrained position is achieved by sliding the slider 162 back until the button 1642 enters the hole 1624 in the slider 162, and gets locked in such a position. In this restrained position the performer can operate with the fingers free of the instrument.

Any and all combinations of the previously described functionalities in one embodiment are possible and included as other alternative embodiments of the holder for switch of instruments' positions.

What is claimed is:

1. A holder for switch of instruments' positions comprising:
a. an instrument holder wherein an instrument or tool can be easily mounted or dismounted by using elastic material, adhesive material, magnetic elements, screwing, hook-and-loop fastening, strings, a coupling structure, a multi-purpose structure or any other means or combination of the above elements,
b. an attaching mechanism such as a ring, a glove, a bracelet, a hook-and-loop strap, a set of magnetic elements, a screw mechanism, a bondable mechanism, a coupling structure, a multi-purpose structure or any other accessory or combination of the above elements allowing the attachment of said instrument holder to a performer's hand or foot,
whereby said instrument holder is mounted on said attaching mechanism and either the instrument holder or the attaching mechanism or the combination of both provide a movable mechanism allowing a performer wearing the holder for switch of instruments' positions to place or displace said instrument or tool in or out of his or her grip.

2. The holder for switch of instruments' positions of claim 1 further including capacity for a plurality of instruments to be mounted and dismounted, so that the performer can easily place or displace a selected instrument in or out of his or her grip.

3. The holder for switch of instruments' positions of claim 1 wherein said attaching mechanism and said instrument holder make a single unit, such as when this unit is the product of a process of plastic molding.

4. The holder for switch of instruments' positions of claim 3 further including capacity for a plurality of instruments to be mounted and dismounted, so that the performer can easily place or displace a selected instrument in or out of his or her grip.

5. The holder for switch of instruments' positions of claim 1 wherein said attaching mechanism, said instrument holder, and said instrument form a single unit, such as when this unit is the product of a process of plastic molding.

6. The holder for switch of instruments' positions of claim 5 further including a plurality of instruments or functionalities, so that the performer can easily place or displace the selected functionality of said single unit in or out of his or her grip.

7. The holder for switch of instruments' positions of claim 1 wherein said instrument holder or said attaching mechanism or the combination of both provide a swiveling mechanism, a sliding mechanism, a hinged mechanism, a releasable mechanism or any other movable mechanism that allows positioning said instrument in or out of the performer's grip.

8. The holder for switch of instruments' positions of claim 1 wherein said instrument holder or said attaching mechanism have variations in shape or materials in order to facilitate the attachment of said attaching mechanism to the fingers or the attachment of an instrument to said instrument holder or to achieve an ergonomic and comfortable performance.

9. The holder for switch of instruments' positions of claim 1 wherein said instrument is attached to the instrument holder in ways such as placing the instrument into an element that exerts pressure on it, holding said instrument with a strap or string, introducing either part into a socket, securing either part with screws, using magnetic attraction, joining hook-and-loop surfaces, matching a female and male threads, engaging both parts with hooks, using adhesive materials or any other joining mechanism.

10. The holder for switch of instruments' positions of claim 1 wherein said movable mechanism to switch between the instrument's positions, in and out of the performers' grip, is a pivot mechanism, a sliding mechanism, a rotational mechanism, a releasable mechanism, or an automatic mechanism.

11. A method of using a holder for switch of instruments' positions through which an instrument is intermittently changed between two positions, one in which the performer hold said instrument and another in which the instrument remains reachable for the fingers, but the fingers can operate without being hindered by said instrument. This method comprises:
a. Mounting the attaching mechanism of said holder for switch of instruments' positions on one or several fingers or on the hand or foot according to the characteristics of said attaching mechanism, for example, by adjusting a hook-and-loop strap to the wrist or by putting a ring on a finger.
b. Mounting one or several instruments on the instrument holder of the holder for switch of instruments' positions according to the characteristics of said instrument holder, for example, by means of a socket, an elastic band, two superposed splints, etc.
c. Moving the instrument in or out of the fingers' grip automatically or by exerting mild pressure on the instrument or instrument holder in the direction allowed by the movable mechanism of said holder for switch of instruments' positions, for example, pivotally if said mechanism is a rivet or linearly if said mechanism is retractable.

12. The method of claim 14 wherein action b is performed before action a.

13. The method of claim 11 whereby said holder for switch of instruments' positions allows positioning the instrument in or out of the performer's grip by means of moving the instrument or the instrument holder around a pivot.

14. The method of claim 11 whereby said holder for switch of instruments' positions allows positioning said instrument in or out of the performer's grip by means of sliding the instrument or the instrument holder along a slit, a chamber or any other slideway.

15. The method of claim 11 whereby said holder for switch of instruments' positions allows positioning said instrument in or out of the performer's grip by means of moving the instrument or the instrument holder about a hinge.
